(19) United States
(12) Patent Application Publication
(10) Pub. No.: US 2023/0234329 A1
(43) Pub. Date: Jul. 27, 2023

(54) DECORATIVE PANEL COMPRISING A TEXTILE DECORATIVE LAYER

(71) Applicant: FLOORING INDUSTRIES LIMITED, SARL, Bertrange (LU)

(72) Inventor: Jan DE RICK, Geraardsbergen (BE)

(21) Appl. No.: 17/927,652

(22) PCT Filed: May 19, 2021
(86) PCT No.: PCT/IB2021/054309

§ 371 Date: Nov. 23, 2022

Related U.S. Application Data
(60) Provisional application No. 63/031,893, filed on May 29, 2020.

(51) Int. Cl. B32B 5/26; E04F 15/02; E04F 15/10; B32B 7/12; B32B 7/10; B32B 3/10; B32B 7/06; B32B 3/02; B32B 37/12; B32B 37/06

(52) U.S. Cl. CPC B32B 5/26; E04F 15/02038; E04F 15/102; E04F 15/107; B32B 7/12; B32B 7/10; B32B 3/10; B32B 7/06; B32B 3/02; B32B 37/1284; B32B 37/06; B32B 2305/18; B32B 2305/30; B32B 2367/00; B32B 2451/00

(57) ABSTRACT

The decorative panel includes a substrate and a top layer. The substrate has at least one of polyvinyl chloride layer. The top layer includes a decorative textile layer providing the surface of the decorative panel. The top layer is laminated onto the substrate by thermal bonding of the top layer onto the substrate; or by a polyvinyl chloride based adhesive layer. The substrate is provided at a first pair of opposite edges with coupling parts, substantially in the form of male coupling parts and female coupling parts, for coupling two such panels to each other at their first pair of opposite edges. The coupling parts are provided with locking means which effects a locking in coupled condition of two such panels in the direction perpendicular to the surface of the coupled panels and/or into the direction perpendicular to the respective edges in the plane of the panels.

### TECHNICAL FIELD

The invention relates to field of decorative panels comprising a textile decorative layer. The panels of the invention can e.g. be used as floor panels, as wall panels or as ceiling panels.

### BACKGROUND ART

Decorative panels exist with different types of decorative surfaces. WO2019/137966A1 discloses a carpet tile. The carpet tile comprises a base, preferably a primary carpet base having pile yarns projecting upwardly therefrom. The carpet tile further comprises a backing structure attached to a lower side of the base. The backing structure comprises an elastic layer, made from an anisotropic material, defining a lower surface of the tile. A plurality of superficial suction holes is formed in at least a lower surface of the elastic layer. The superficial suction holes are open in a direction facing away from the base and substantially closed in a direction facing the base. The superficial suction holes together define a void footprint. Material at the lower surface of the elastic layer in between the superficial suction holes define a material footprint. The ratio between the void footprint and the material footprint is at least 4, thereby allowing the tile to be quickly attached to a support surface and removed from the support surface. Optionally, the tile can be provided at at least one pair of opposite tile edges with a pair of complementary coupling parts allowing a plurality of such tiles to be connected. The complementary coupling parts can be configured to couple at least two tiles, such that a locking of the tiles in a first direction, perpendicular to a plane of the tile, and also a locking of the tiles in a second direction, parallel to the plane of the panel, is realized.

WO2011/085306A1 discloses a plank comprising a resilient composite sheet having four sides, an upper surface, a lower surface, and an overall thickness. The composite sheet comprises at least one base layer. The at least one base layer comprises at least one polymeric material and at least one filler. Opposite sides of the composite sheet comprise a first tongue on a first side and a first groove on the opposite second side. The first tongue and first groove have complementary shape to each other to be interlockingly engageable with a corresponding groove or tongue on an adjacent floor plank. The plank can be provided with a carpet layer.

### DISCLOSURE OF THE INVENTION

It is an objective of the invention to provide decorative panels that have a textile decorative layer that can be installed in a floating manner and that can be manufactured more easily. It is a further objective to provide manufacturing methods to produce such decorative panels.

It is a particular objective of embodiments of the invention to provide decorative panels that have a textile decorative layer, that are easy to manufacture, that can be easily installed and that over time the unlevelness and uneveness of the support onto which the decorative panels are positioned does not shine through.

To these ends, the invention comprises several independent aspects.

The first aspect of the invention is a decorative panel. The decorative panel comprises a substrate and a top layer. The substrate comprises one or a multiple number of polyvinyl chloride layers. The top layer comprises a decorative textile layer providing the surface of the decorative panel. The top layer is laminated onto the substrate by thermal bonding of the top layer onto the substrate; or by means of a polyvinyl chloride based adhesive layer. The substrate is provided at a first pair of opposite edges with coupling parts, substantially in the form of male coupling parts and female coupling parts, for coupling two such panels to each other at their first pair of opposite edges. The coupling parts are provided with locking means which effects a locking in coupled condition of two such panels in the direction perpendicular to the surface of the coupled panels and/or into the direction perpendicular to the respective edges in the plane of the panels.

The decorative panel of the first aspect of the invention can be manufactured in an easy way. Lamination of the top layer onto the substrate can be done in an easy way. The coupling parts can be manufactured into the substrate—before or after the lamination process—using known techniques, e.g. by milling processes.

The presence of the coupling parts—with locking means—provides ease of installation of the decorative panels.

In a preferred embodiment wherein the top layer is laminated onto the substrate by means of a polyvinyl based adhesive layer, the polyvinyl based adhesive layer is plasticized polyvinyl chloride; and/or the polyvinyl based adhesive layer comprises one or more than one of cyclohexanone, tetrahydrofuran or butanone. More preferably, the plasticized polyvinyl chloride of the polyvinyl based adhesive layer is applied as a plastisol. Such embodiments provide particularly easy ways of lamination of the top layer onto the substrate. The use of one or more of cyclohexanone, tetrahydrofuran or butanone in the polyvinyl based adhesive layer creates a plasticizing effect; and improves adhesion between the surfaces glued together by the adhesive layer.

Preferably, the top layer is laminated onto the substrate by means of a polyvinyl chloride based adhesive layer, wherein the polyvinyl chloride based adhesive layer is provided over the full surface of the substrate.

Preferably, the top layer is laminated onto the substrate by means of a polyvinyl based adhesive layer; and the polyvinyl chloride based adhesive layer is not provided over the full surface of the substrate, but according to a regular or non-regular pattern. The adhesive can e.g. be provided on the substrate as discrete dots or in a grid pattern. Such embodiments provide easy ways of lamination of the top layer onto the substrate while the consumption of adhesive is limited.

Preferably, the top layer comprises a backing layer providing the bottom of the top layer. The presence of the backing layer facilitates the lamination process.

More preferably, the backing layer comprises polyvinyl chloride, e.g. plasticized polyvinyl chloride. Such embodiments are particularly beneficial, as the similarity of the material of the backing layer (polyvinyl chloride) with the polyvinyl chloride of the substrate facilitates lamination of the top layer onto the substrate.

The substrate of preferred decorative panels comprises as its upper layer a plasticized polyvinyl chloride layer. The plasticized polyvinyl chloride layer adheres directly or indirectly to the top layer. With adheres indirectly is meant that the adhesion is achieved by means of an adhesive layer, preferably an adhesive layer comprising polyvinyl chloride. The use of plasticized polyvinyl chloride facilitates the lamination.

Preferred substrates comprise a backing layer providing the bottom layer of the decorative panel. More preferably, the backing layer comprises or consists of a plasticized polyvinyl chloride layer, optionally comprising a reinforcement layer, e.g. a glass nonwoven, a glass grid or a woven glass fabric. The use of a backing layer provides beneficial properties to the decorative panel.

The decorative textile layer of preferred embodiments comprises any one of a nonwoven felt—e.g. a needled felt—, a layer of flocked fibers, a layer of cut pile yarns, a layer of loop pile yarns, or a woven fabric with or without pile yarns; providing the surface of the decorative panel.

More preferably, the top layer comprises a carrier substrate onto which the decorative textile layer is adhered. More preferably the carrier substrate comprises or consists of a textile nonwoven fabric or a woven fabric.

If the decorative layer comprises a nonwoven felt—e.g. a needled felt—the nonwoven felt can be provided onto the carrier substrate, or the carrier substrate can be embedded inside the nonwoven felt (e.g. a needle felt reinforced with a scrim fabric).

If the decorative layer comprises a layer of flocked fibers, the flocked fibers can be flocked onto a carrier substrate. The carrier substrate can be a textile fabric, e.g. a nonwoven fabric, e.g. a nonwoven glass fabric. Optionally the carrier substrate can comprise a backing layer, preferably comprising polyvinyl chloride, more preferably plasticized polyvinyl chloride.

If the decorative layer comprises a layer of cut pile yarns or a layer of loop pile yarns; the pile yarns—whether loop pile yarns or cut pile yarns—can be tufted in a carrier substrate, or the pile yarns can be glued on top of a carrier substrate.

In preferred embodiments wherein the top layer comprises a carrier substrate onto which the decorative textile layer is adhered, the top layer can comprise a precoat and/or a secondary backing. The top layer can e.g. be a cut pile and/or loop pile tufted or bonded carpet; optionally comprising a precoat and a secondary backing. The precoat and/or the secondary backing preferably comprise polyvinyl chloride, more preferably plasticized polyvinyl chloride.

Preferably, the decorative textile layer comprises any one or a combination of polyamide fibers (e.g. PA 6.6, or PA6), polyester fibers (e.g. polyethylene terephthalate fibers), polypropylene fibers, wool fibers, sisal fibers, jute fibers, rayonne fibers, cotton fibers; or blends thereof.

The substrate of preferred embodiments comprises or consists of a Wood Plastic Composite (WPC), a Luxury Vinyl Tile (LVT) or a Stone Plastic Composite (SPC).

The substrate of preferred embodiments comprises a core. The core comprises a thermoplastic polymer—preferably polyvinylchloride—comprising filling material, e.g. one or more of stone particles, chalk, wood fibers or natural fibers. Preferably, the filling material is wood based or is a mineral filling material.

In preferred embodiments, the substrate is substantially a synthetic composite material. The synthetic composite material comprises a polyvinyl chloride matrix. The synthetic composite material comprises filling material. Preferably the density of the filling material is higher than the density of the material of the polyvinyl chloride matrix.

More preferably, the filling material is wood based or is a mineral filling material. The filling material can e.g. be one or more than one of stone particles, chalk, wood fibers, wood particles or natural fibers.

More preferably, the polyvinyl chloride of the polyvinyl chloride matrix is free from plasticizers or comprises plasticizers in an amount less than 20 phr; more preferably in an amount between 5 and 15 phr; even more preferably in an amount less than 5 phr. Preferably the first layer provides at least 50% of the thickness of the decorative panel. Such embodiments provide a rigid substrate, and hence a rigid decorative panel. Such embodiments provide the benefit that a decorative panel is provided with a rigid substrate. The presence of a rigid substrate is particularly beneficial when using the decorative panel as floor panel, as the rigid substrate prevents that unevenness of the support layer onto which the decorative panel is placed shines through over time to the surface of the flooring provided by the decorative panels.

Preferably, the amount of filling material in the synthetic composite material is at least 40 percent by weight, preferably at least 50 percent by weight, more preferably 65 percent by weight, even more preferably more than 80 percent by weight.

In preferred embodiments, the polyvinyl chloride of the core or of the polyvinyl chloride matrix is foamed polyvinyl chloride.

The substrate of preferred decorative panels comprises a first layer and a second layer. The second layer is provided above the first layer. With above the first layer is meant that the second layer is located closer to the top layer than the first layer. The first layer comprises polyvinyl chloride. The second layer comprises plasticized polyvinyl chloride, preferably wherein the amount of plasticizers in more than 20 phr. The composition of the second layer is more supple than the composition of the first layer. The more supple second layer provides sound dampening properties to the

More preferably, the polyvinyl chloride of the first layer is free from plasticizers or comprises plasticizers in an amount less than 20 phr (parts per hundred resin), more preferably in an amount between 5 and 15 phr; even more preferably in an amount less than 5 phr. Preferably the first layer provides at least 50% of the thickness of the decorative panel.

The polyvinyl chloride of the first layer is preferably foamed.

The polyvinyl chloride of the first layer preferably comprises filling material, e.g. one or more of stone particles, chalk, wood fibers or natural fibers. The filling material is preferably a mineral filling material or a wood-based filling material (e.g. wood fiber or wood particles).

Preferably, the amount of filing material in the first layer is at least 40 percent by weight, preferably at least 50 percent by weight, more preferably 65 percent by weight, even more preferably more than 80 percent by weight.

A preferred decorative panel is rectangular, square or oblong.

The coupling parts of the first pair of opposite edges of preferred decorative panels are configured such that two such panels can be coupled at the first pair of opposite edges by means of a turning movement and/or by means of a sliding movement with snap effect parallel with the surface of the decorative panels.

Preferably, the coupling parts at the first pair of opposite edges are substantially manufactured of the material of the substrate. The coupling parts at the first pair of opposite edges substantially are realized in the form of a tongue and a groove, which are provided with locking parts, which, in the coupled condition of two of such floor panels, counteract the moving apart of the coupled floor panels in a direction perpendicular to the coupled edges and parallel to the plane of the floor covering. The groove is bordered by an upper lip and a lower lip, which lower lip, in distal direction, extends beyond the distal end of the upper lip, and, the portion of the lower lip that extends beyond the distal end of the upper lip comprises a locking part in the form of an upward-directed locking part.

The coupling parts of the first pair of opposite edges are preferably configured such that two such panels can be coupled at the first pair of opposite edges by means of a substantially downward movement according to a direction perpendicular to the plane of the panels, and/or by means of a turning movement, and/or by means of a sliding movement with snap effect parallel with the surface of the decorative panels.

The substrate of particularly preferred decorative panels is provided at a second pair of opposite edges with coupling parts, substantially in the form of male coupling parts and female coupling parts, for coupling two such panels to each other at their second pair of opposite edges. The coupling part at the second pair of opposite edges are provided with locking means which effects a locking in coupled condition of two such panels in the direction perpendicular to the surface of the coupled panels and/or into the direction perpendicular to the respective edges in the plane of the panels. The coupling parts of the second pair of opposite edges are configured such that two such panels can be coupled at the second pair of opposite edges by means of a substantially downward movement according to a direction perpendicular to the plane of the panels, and/or by means of a turning movement, and/or by means of a sliding movement with snap effect parallel with the surface of the decorative panels.

In a particularly preferred embodiment, the decorative panel is provided at the first pair of opposite edges with coupling parts configured such that two such panels can be coupled at the first pair of opposite edges by means of a turning movement; and at a second pair of opposite edges with coupling parts configured such that two such panels can be coupled at the second pair of opposite edges by means of a substantially downward movement according to a direction perpendicular to the plane of the panels. Such embodiments allow that the installation of the panels can be done using the fold-down installation method.

The second aspect of the invention is a method for manufacturing a decorative panel comprising a decorative textile layer, optionally a decorative panel as in any embodiment of the first aspect of the invention. The method comprises the steps of
providing a substrate wherein the substrate comprises one or a multiple number of polyvinyl chloride layers;
providing a top layer comprising a decorative textile layer;
laminating the top layer onto the substrate by thermal bonding of the top layer onto the substrate; or by means of a polyvinyl chloride based adhesive layer, thereby obtaining a board;
dividing the board into a plurality of panels each comprising the top layer laminated onto the substrate;
providing the panels at least at a first pair of their opposite edges with coupling parts, substantially in the form of male coupling parts and female coupling parts, for coupling two such panels to each other at their first pair of opposite edges; wherein the coupling parts are provided with locking means which effects a locking in coupled condition of two such panels in the direction perpendicular to the surface of the coupled panels and/or into the direction perpendicular to the respective edges in the plane of the panels.

Such method provides a particularly easy method to make a decorative panel having a decorative textile layer.

In a preferred embodiment of the method of the second aspect of the invention, the top layer is laminated onto the substrate by thermal bonding. The top layer of the substrate and/or the bottom of the top layer is heated before contacting the top layer onto the substrate. More preferably, the heating is performed by means of infrared radiation.

In a preferred embodiment of the method of the second aspect of the invention, the top layer is laminated onto the substrate by thermal bonding. The top layer is brought in contact with the substrate; and the combination of top layer and substrate passes through heated rollers; or through pressure belts while heat is applied.

In a preferred method of the second aspect of the invention, the surface of the substrate brought in contact with the top layer comprises or consists of plasticized polyvinyl chloride and/or the surface of the top layer brought in contact with the substrate comprises or consists of plasticized polyvinyl chloride. Similarity of materials in or of the substrate and the top layer facilitates the lamination process.

In a preferred method of the second aspect of the invention, the top layer is laminated onto the substrate by means of a polyvinyl chloride based adhesive; preferably wherein the polyvinyl based adhesive layer is plasticized polyvinyl chloride (the use of a plastisol is particularly preferred) and/or the polyvinyl based adhesive layer comprises one or more than one of cyclohexanone, tetrahydrofuran or butanone. The polyvinyl chloride based adhesive is preferably applied in line with the lamination process onto the substrate, the top layer or onto both.

In a preferred method, the polyvinyl chloride based adhesive is applied uniformly onto the substrate, the top layer or onto both.

In a preferred method, the polyvinyl chloride based adhesive layer is not uniformly applied, but applied according to a regular or non-regular pattern. The adhesive can e.g. be provided on the substrate and/or on the top layer as discrete dots or in a grid pattern.

The third aspect of the invention is a method for manufacturing a decorative panel comprising a decorative textile layer, optionally a decorative panel as in any embodiment of the first aspect of the invention. The method comprises the steps of
providing a substrate, wherein the substrate is selected from an MDF (Medium Density Fiberboard) panel, a HDF (High Density Fiberboard) panel, a mineral board (e.g. based on cement, on lime cement, on magnesium cement or on gypsum), a polyvinyl sheet, a multilayered polyvinyl chloride sheet or a multilayered polyvinyl chloride panel;
applying an adhesive onto the substrate;
flocking discrete textile fibers into the adhesive, wherein a flocked board is manufactured;
dividing the board into a plurality of panels each comprising the flocked discrete textile fibers;
providing the panels at least at a first pair of their opposite edges with coupling parts, substantially in the form of male coupling parts and female coupling parts, for coupling two such panels to each other at their first pair of opposite edges; wherein the coupling parts are provided with locking means which effects a locking in coupled condition of two such panels in the direction perpendicular to the surface of the coupled panels and/or into the direction perpendicular to the respective edges in the plane of the panels. Preferably, the coupling parts are substantially provided in the substrate.

The method of the third aspect of the invention provides a particularly easy way of manufacturing a decorative panel having a decorative textile layer.

The fourth aspect of the invention is a method for manufacturing a decorative panel comprising a decorative textile layer, optionally a decorative panel as in any embodiment of the first aspect of the invention. The method comprises the steps of
providing a substrate, wherein the substrate is selected from an MDF panel, a HDF panel, a mineral board (e.g. based on cement, on lime cement, on magnesium cement or on gypsum), a polyvinyl chloride sheet, a multilayered polyvinyl chloride sheet or a multilayered polyvinyl chloride panel;
applying an adhesive onto the substrate;
putting textile yarns into the adhesive, wherein a board is manufactured comprising yarns providing a cut pile or a loop pile;
dividing the board into a plurality of panels each comprising yarns providing a cut pile or a loop pile;
providing the panels at least at a first pair of their opposite edges with coupling parts, substantially in the form of male coupling parts and female coupling parts, for coupling two such panels to each other at their first pair of opposite edges; wherein the coupling parts are provided with locking means which effects a locking in coupled condition of two such panels in the direction perpendicular to the surface of the coupled panels and/or into the direction perpendicular to the respective edges in the plane of the panels. Preferably, the coupling parts are substantially provided in the substrate. The method of the fourth aspect of the invention provides a particularly easy way of manufacturing a decorative panel having a decorative textile layer.

The fifth aspect of the invention is a method for manufacturing a decorative panel comprising a decorative textile layer, optionally a decorative panel as in any embodiment of the first aspect of the invention. The method comprises the steps of
providing a substrate, wherein the substrate is selected from an MDF panel, a HDF panel, a mineral board (e.g. based on cement, on lime cement, on magnesium cement or on gypsum), a polyvinyl chloride sheet, a multilayered polyvinyl chloride sheet or a multilayered polyvinyl chloride panel;
providing the substrate at least at a first pair of its opposite edges with coupling parts, substantially in the form of male coupling parts and female coupling parts, for coupling two panels each comprising such substrate to each other at their first pair of opposite edges; wherein the coupling parts are provided with locking means which effects a locking in coupled condition of two panels each comprising such substrate in the direction perpendicular to the surface of the coupled panels and/or into the direction perpendicular to the respective edges in the plane of the panels;
applying a top layer onto the substrate, wherein the top layer comprises a decorative textile layer providing the surface of the decorative panel.

The method of the fifth aspect of the invention provides a particularly easy way of manufacturing a decorative panel having a decorative textile layer.

In a preferred method according to the fifth aspect of the invention, the top layer is provided as a web or sheet. The method comprises the step of laminating the topic layer onto the substrate, e.g. wherein the top layer is a tufted carpet, a needle felt or a flocked web. More preferably, the method of lamination is thermal lamination or lamination by means of the application of an adhesive.

In a preferred method according to the fifth aspect of the invention, the top layer the top layer is applied onto the substrate by adhering fibres and/or yarns directly or indirectly onto the substrate. More preferably, an adhesive is applied onto the substrate, or the upper layer of the substrate is tackified by heating it; and discrete fibers and/or yarns are adhered to the adhesive or to the tackified upper layer of the substrate. When discrete fibers are used in such method, the method can comprise flocking the fibers. When yarns are used in the process, the yarns can be adhered to the substrate to form a cut pile or a loop pile decorative surface.

In a preferred method according to any embodiment of any one of the second, third, fourth or fifth aspect of the invention, the substrate is substantially a synthetic composite material. The synthetic composite material comprises a polyvinyl chloride matrix. The synthetic composite material comprises filling material, preferably wherein the density of the filling material is higher than the density of the material of the polyvinyl chloride matrix.

More preferably, the polyvinyl chloride of the polyvinyl chloride matrix is free from plasticizers or comprises plasticizers in an amount less than 20 phr; even more preferably in an amount between 5 and 15 phr; even more preferably in an amount less than 5 phr.

In a preferred method according to any embodiment of any one of the first, second, third, fourth or fifth aspect of the invention, the amount of filling material in the synthetic composite material is at least 40 percent by weight, preferably at least 50 percent by weight, more preferably 65 percent by weight, even more preferably more than 80 percent by weight.

Preferably, the polyvinyl chloride of the polyvinyl chloride matrix is foamed polyvinyl chloride.

In a preferred method according to any embodiment of any one of the second, third, fourth or fifth aspect of the invention, the substrate comprises a first layer and a second layer. The second layer is provided above the first layer. It is meant that the second layer is provided closer to the top layer than the first layer. The first layer comprises polyvinyl chloride. The second layer comprises plasticized polyvinyl chloride, preferably wherein the amount of plasticizers in more than 20 phr. The composition of the second layer is more supple than the composition of the first layer.

More preferably, the polyvinyl chloride of the first layer is free from plasticizers or comprises plasticizers in an amount less than 20 phr; more preferably in an amount between 5 and 15 phr; even more preferably in an amount less than 5 phr.

In preferred methods of any embodiment of the method of the second, third, fourth or fifth aspect of the invention, the polyvinyl chloride of the first layer is foamed.

Preferably, the polyvinyl chloride of the first layer comprises filling material, e.g. one or more of stone particles, chalk, wood fibers or natural fibers, or the filling material is a mineral filling material or a wood-based filling material. More preferably, the amount of filing material in the first layer is at least 40 percent by weight, preferably at least 50 percent by weight, more preferably 65 percent by weight, even more preferably more than 80 percent by weight.

The sixth aspect of the invention is a decorative panel. The decorative panel comprises a substrate and a top layer. The substrate comprises one or a multiple number of layers. The top layer comprises a decorative textile layer providing the surface of the decorative panel. The substrate is provided at a first pair of opposite edges with coupling parts, substantially in the form of male coupling parts and female coupling parts, for coupling two such panels to each other at their first pair of opposite edges. The coupling parts are provided with locking means which effects a locking in coupled condition of two such panels in the direction perpendicular to the surface of the coupled panels and/or into the direction perpendicular to the respective edges in the plane of the panels; The substrate comprises a thermoplastic polymer. The top layer is laminated onto the substrate by thermal lamination wherein bonds are formed between the thermoplastic polymer of the substrate and the same thermoplastic polymer in the top layer.

The decorative panel of the sixth aspect of the invention can be manufactured in a particularly easy way.

In a preferred embodiment of the sixth aspect of the invention, the top layer comprises a backing layer. The same thermoplastic polymer is provided in the top layer as is provided in the backing layer of the top layer.

The seventh aspect of the invention is a decorative panel. The decorative panel comprises a substrate and a top layer. The substrate comprises one or a multiple number of layers. The top layer comprises a decorative textile layer providing the surface of the decorative panel. The substrate is provided at a first pair of opposite edges with coupling parts, substantially in the form of male coupling parts and female coupling parts, for coupling two such panels to each other at their first pair of opposite edges. The coupling parts are provided with locking means which effects a locking in coupled condition of two such panels in the direction perpendicular to the surface of the coupled panels and/or into the direction perpendicular to the respective edges in the plane of the panels. The substrate comprises a thermoplastic polymer. The top layer is laminated onto the substrate by means of a thermoplastic adhesive, wherein bonds are formed between the thermoplastic adhesive and the thermoplastic polymer of the substrate. The thermoplastic adhesive comprises—and preferably consists of—the same thermoplastic polymer as the thermoplastic polymer comprised in the substrate. More preferably, the thermoplastic polymer is a polyester, and the thermoplastic adhesive is a co-polyester.

In preferred decorative panels according to the sixth or seventh aspect of the invention, the thermoplastic polymer is selected from polyvinyl chloride, polyethylene, polypropylene, polyester, or polyamide.

The decorative panels according to the different aspects of the invention can advantageously be used as wall panel or as ceiling panel as such panels provide sound dampening effects to the rooms in which they are installed.

The decorative panels according to the different aspects of the invention can be used as floor panels.

### BRIEF DESCRIPTION OF THE FIGURES

FIG. 1 represents a partially installed floor covering composed of decorative floor panels according to embodiments of several aspects of the invention.

FIG. 2 shows in top view a decorative floor panel used in the floor covering of FIG. 1.

FIG. 3 represents a cross-section according to line III-III in FIG. 2.

FIG. 4 represents a cross-section according to line IV-IV in FIG. 2.

FIG. 5 shows—in a same view as in FIG. 3—an alternative embodiment of the invention.

FIGS. 6, 7 and 8 show alternative top layers that can be used in the invention.

### MODE(S) FOR CARRYING OUT THE INVENTION

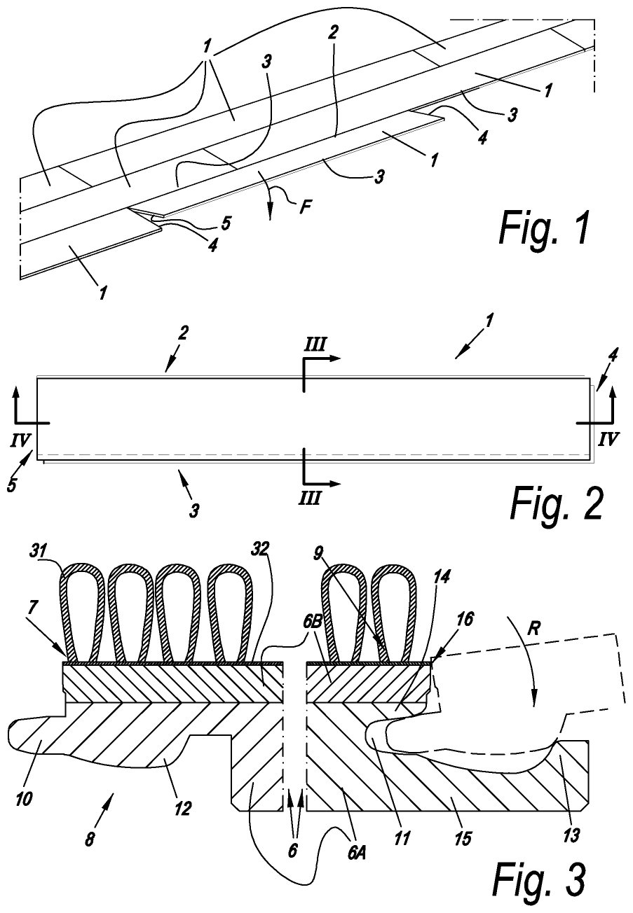

FIG. 1 represents a partially installed floor covering composed of decorative floor panels 1 according to embodiments of several aspects of the invention. These decorative floor panels 1 comprise coupling parts at the first pair of opposite edges 2, 3—which are the long edges of the rectangular and oblong panels. The coupling parts are substantially provided in the form of male coupling parts and female coupling parts, for coupling two such panels to each other at their first pair of opposite edges. The coupling parts of the first pair of opposite edges 2, 3 are configured such that two such panels can be coupled at the first pair of opposite edges by means of a turning movement.

The second pair of opposite edges 4, 5—which are the short edges—are also provided with coupling parts provided in the form of male coupling parts and female coupling parts, for coupling two such panels 1 to each other at their second pair of opposite edges. The coupling parts of the second pair of opposite edges 4, 5 are configured such that two such panels 1 can be coupled at the second pair of opposite edges 4, 5 by means of a substantially downward movement according to a direction perpendicular to the plane of the panels. Such downward movement is possible with coupling parts of the so-called “push-down”, “push-lock” or “drop” type.

Thanks to the specific configuration of the coupling parts, the decorative floor panel 1, starting from an inclined position, can be coupled in a single movement F at its long edge 2 as well as at its short edge 5 to the respective already installed floor panels 1. This installation method of floor panels is known as “fold-down” installation. The fold-down movement F offers the possibility of installing a floor covering in a very simple and efficient manner using decorative floor panels according to the invention.

FIG. 2 shows in top view a decorative floor panel 1 used in the floor covering of FIG. 1. The decorative floor panel 1 is a decorative panel according to several aspects of the invention. The decorative floor panel 1 is rectangular and in this case oblong and comprises a first pair of opposite edges 2, 3, which form the long edges, and a second pair of opposite edges 4, 5, which form the short edges.

FIG. 3 represents a cross-section according to line III-III in FIG. 2. The floor panel 1 comprises a layer-shaped substrate 6, as well as a decorative top layer 7 situated above the substrate 6. The top layer 7 comprises a decorative textile layer, in this example comprising loop pile yarns 31 on a backing layer 32 providing the bottom of the top layer 7. In the example shown, the backing layer 32 comprises polyvinyl chloride, e.g. plasticized polyvinyl chloride.

The substrate 6 comprises at least one layer 6A, which is made on the basis of a composition comprising at least polyvinyl chloride, wherein the composition is free from plasticizers or comprises plasticizers in an amount of less than 20 phr and preferably in an amount between 5 and 15 phr. The result is a rigid layer 6A. The polyvinyl chloride of the layer 6A can be foamed; and may comprise fillers such as mineral fillers or wood-based fillers.

The substrate 6 comprises a more supple layer 6B situated above the layer 6A. This more supple layer 6B is a polyvinyl chloride layer comprising plasticizers in an amount more than 20 phr. The more supply layer 6B may comprise fillers such as mineral fillers of wood-based fillers.

Preferably, the layer 6A forms at least half of the thickness of the decorative floor panel 1.

The top layer 7 is laminated onto the substrate 6 by thermal bonding of the top layer onto the substrate (and more specifically to the more supple layer 6B).

The first pair of opposite edges 2, 3 is provided with coupling parts 8, 9, which allow effecting a coupled condition between two of such coupling parts 1 by means of a rotation or turning movement R around an axis parallel to the plane of the floor covering and parallel to the edges 2, 3 to be coupled.

The coupling parts 8, 9 substantially are made from the material of the substrate 6 and more particularly substantially in the rigid layer 6A.

Substantially, the coupling parts at the first pair of opposite edges are realized in the form of a tongue 10 and a groove 11, which are provided with locking parts 12, 13, which, in the coupled condition of two of such floor panels 1, counteract the moving apart of the coupled floor panels 1 in a direction perpendicular to the coupled edges 2, 3 and parallel to the plane of the floor covering.

The groove 11 is bordered by an upper lip 14 and a lower lip 15, which lower lip 15 in distal direction reaches beyond the distal end 16 of the upper lip 14 and, beyond the distal end 16 of the upper lip 14, comprises a locking part 13 in the form of an upward-directed locking part 13. This way, a locking in coupled condition of two such panels at their first pair of opposite edges is provided in the direction perpendicular to the surface of the coupled panels and into the direction perpendicular to the respective edges in the plane of the panels.

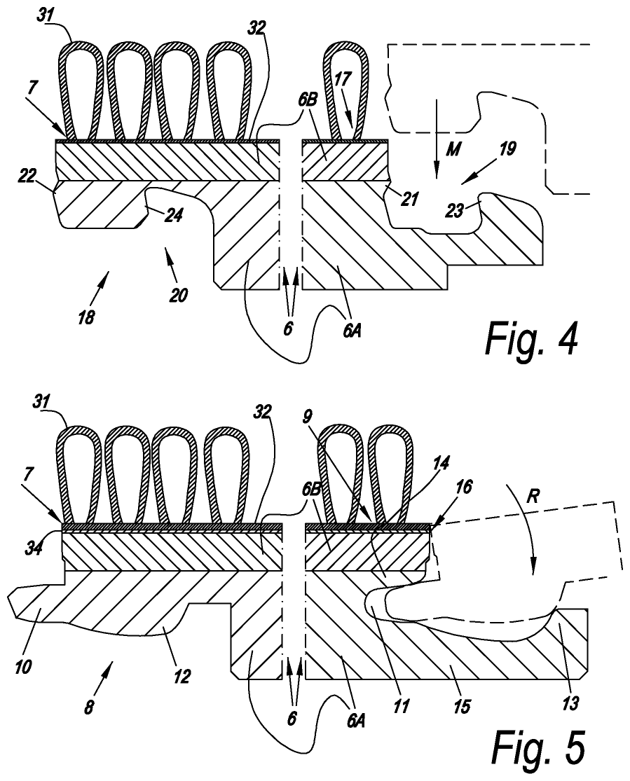

FIG. 4 represents a cross-section according to line IV-IV in FIG. 2. The reference figures in FIG. 4 have the same meaning as in FIG. 3. The second pair of opposite edges 4, 5 is provided with coupling parts 17, 18, which allow effecting a coupled condition between two of such floor panels 1 by means of a substantially downward movement M according to a direction perpendicular to the plane of the floor covering. The coupling parts 17, 18 here are made as hook-shaped portions 19, 20, which form a locking system which allows effecting a locking between two of such floor panels 1 in a direction parallel to the plane of the floor covering and perpendicular to the coupled edges 4, 5. The coupling parts 17, 18 further comprise locking parts 21, 22 and locking parts 23, 24, which each form a locking system which allows effecting a locking between two of such floor panels 1 in a direction perpendicular to the plane of the floor covering. The coupling parts 8, 9 and 17, 18 at the first and the second pair of opposite edges 2, 3 and 4-5 allow effecting a coupled condition between a plurality of such floor panels 1 by means of a fold-down movement F, as illustrated in FIG. 1.

FIG. 5 shows—in a same view as in FIG. 3—an alternative embodiment of the invention. The panel has a similar configuration as the panel shown in FIG. 3. The reference numerals in FIG. 5 have the same meaning as the reference numerals in FIG. 3. The decorative panel illustrated in FIG. 5 differs from the panel illustrated in FIG. 3 in that the top layer is laminated onto the substrate (and more specifically to the more supple layer 6B of the substrate 6) by means of a polyvinyl chloride based adhesive layer 34.

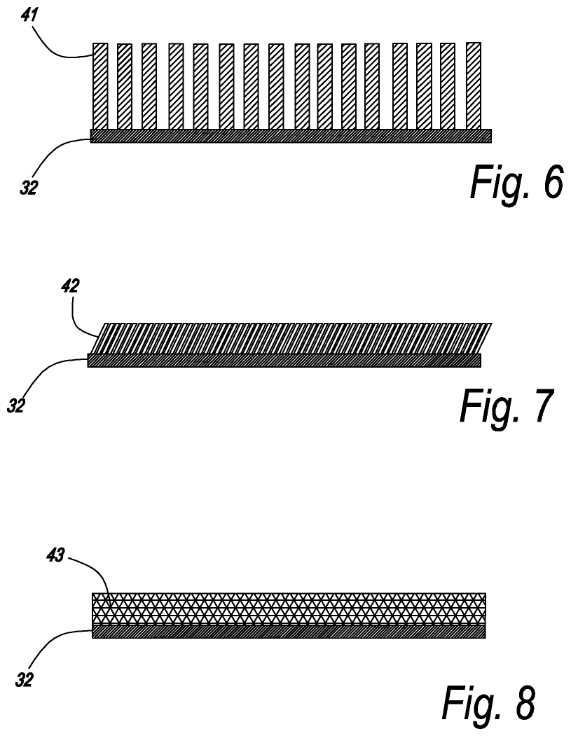

FIGS. 6, 7 and 8 show alternative top layers that can be used in the invention. The top layer shown in FIG. 6 comprises a backing layer 32 and cut pile yarns 41. And example of such top layer is a tufted or bonded cut pile carpet. The top layer can comprise a precoat and/or a secondary backing layer.

The top layer of FIG. 7 comprises a backing layer 32 onto which discrete fibers 42 are adhered. The top layer of FIG. 7 can be manufactured by means of flocking: the backing layer—e.g. comprising a woven or nonwoven fabric, e.g. a nonwoven glass fiber fabric—is provided with an adhesive onto which the discrete fibers are applied. This way, the fibers are glued onto the backing layer.

FIG. 8 shows yet an alternative top layer. The top layer comprises a backing layer 32 onto which a nonwoven 43—e.g. a needlefelt—is adhered, e.g. by means of an adhesive. The use of a top layer which consist of a needlefelt, and thus do not comprise a backing layer is also possible according to the invention.

The use of the decorative panels is not limited to use in floor coverings. Decorative panels according to the invention can also be used in wall coverings of ceiling coverings.

1.-54. (canceled)

55. A decorative panel, comprising a substrate and a top layer,
wherein the substrate comprises one or a multiple number of polyvinyl chloride layers,
wherein the top layer comprises a decorative textile layer providing the surface of the decorative panel;
wherein the top layer is laminated onto the substrate by thermal bonding of the top layer onto the substrate; or by means of a polyvinyl chloride based adhesive layer;
wherein the substrate is provided at a first pair of opposite edges with coupling parts, substantially in the form of male coupling parts and female coupling parts, for coupling two such panels to each other at their first pair of opposite edges;
wherein the coupling parts are provided with locking means which effects a locking in coupled condition of two such panels in the direction perpendicular to the surface of the coupled panels and/or into the direction perpendicular to the respective edges in the plane of the panels.

56. The decorative panel as in claim 55, wherein the top layer is laminated onto the substrate by means of a polyvinyl based adhesive layer,
wherein the polyvinyl based adhesive layer is plasticized polyvinyl chloride; and/or the polyvinyl based adhesive layer comprises one or more than one of cyclohexanone, tetrahydrofuran or butanone.

57. The decorative panel as in claim 55, wherein the top layer comprises a backing layer providing the bottom of the top layer;
wherein the backing layer comprises polyvinyl chloride.

58. The decorative panel as in claim 55, wherein the substrate comprises as its upper layer a plasticized polyvinyl chloride layer;
wherein said plasticized polyvinyl chloride layer adheres directly or indirectly to the top layer.

59. The decorative panel as in claim 55, wherein the decorative textile layer comprises any one of a nonwoven felt, a layer of flocked fibers, a layer of cut pile yarns, a layer of loop pile yarns, or a woven fabric with or without pile yarns; providing the surface of the decorative panel.

60. The decorative panel as in claim 59, wherein the top layer comprises a carrier substrate onto which the decorative textile layer is adhered; wherein the carrier substrate comprises or consists of a textile nonwoven fabric or a woven fabric.

61. The decorative panel as in claim 55, wherein the substrate comprises a core,
wherein the core comprises polyvinylchloride comprising filling material,
wherein the filling material comprises one or more of stone particles, chalk, wood fibers or natural fibers.

62. The decorative panel as in claim 61, wherein the polyvinyl chloride of the core or of the polyvinyl chloride matrix is foamed polyvinyl chloride.

63. The decorative panel as in claim 55, wherein the coupling parts of the first pair of opposite edges are configured such that two such panels can be coupled at the first pair of opposite edges by means of a turning movement and/or by means of a sliding movement with snap effect parallel with the surface of the decorative panels.

64. The decorative panel as in claim 63, wherein the coupling parts at the first pair of opposite edges substantially are manufactured of the material of the substrate;
wherein the coupling parts at the first pair of opposite edges substantially are realized in the form of a tongue and a groove, which are provided with locking parts, which, in the coupled condition of two of such floor panels, counteract the moving apart of the coupled floor panels in a direction perpendicular to the coupled edges and parallel to the plane of the floor covering;
wherein the groove is bordered by an upper lip and a lower lip, which lower lip, in distal direction, extends beyond the distal end of the upper lip, and, the portion of the lower lip that extends beyond the distal end of the upper lip comprises a locking part in the form of an upward-directed locking part.

65. The decorative panel as in claim 55, wherein the coupling parts of the first pair of opposite edges are configured such that two such panels can be coupled at the first pair of opposite edges by means of a substantially downward movement according to a direction perpendicular to the plane of the panels, and/or by means of a turning movement, and/or by means of a sliding movement with snap effect parallel with the surface of the decorative panels.

66. A method for manufacturing a decorative panel comprising a decorative textile layer;
wherein the method comprises the steps of:
providing a substrate wherein the substrate comprises one or a multiple number of polyvinyl chloride layers;
providing a top layer comprising a decorative textile layer;
laminating the top layer onto the substrate by thermal bonding of the top layer onto the substrate; or by means of a polyvinyl chloride based adhesive layer, thereby obtaining a board;
dividing the board into a plurality of panels each comprising the top layer laminated onto the substrate;
providing the panels at least at a first pair of their opposite edges with coupling parts, substantially in the form of male coupling parts and female coupling parts, for coupling two such panels to each other at their first pair of opposite edges;
wherein the coupling parts are provided with locking means which effects a locking in coupled condition of two such panels in the direction perpendicular to the surface of the coupled panels and/or into the direction perpendicular to the respective edges in the plane of the panels,
wherein the coupling parts are provided substantially in the substrate.

67. The method as in claim 66, wherein the top layer is laminated onto the substrate by thermal bonding,
wherein the top layer of the substrate and/or the bottom of the top layer is heated before contacting the top layer onto the substrate.

68. The method as in claim 66, wherein the top layer is laminated onto the substrate by thermal bonding,
wherein the top layer is brought in contact with the substrate; and the combination of top layer and substrate passes through heated rollers; or through pressure belts while heat is applied.

69. The method as in claim 66, wherein the top layer is laminated onto the substrate by means of a polyvinyl chloride based adhesive;
wherein the polyvinyl based adhesive layer is plasticized polyvinyl chloride and/or the polyvinyl based adhesive layer comprises one or more than one of cyclohexanone, tetrahydrofuran or butanone.

70. A decorative panel, comprising a substrate and a top layer, wherein the substrate comprises one or a multiple number of layers,
wherein the top layer comprises a decorative textile layer providing the surface of the decorative panel;
wherein the substrate is provided at a first pair of opposite edges with coupling parts, substantially in the form of male coupling parts and female coupling parts, for coupling two such panels to each other at their first pair of opposite edges;
wherein the coupling parts are provided with locking means which effects a locking in coupled condition of two such panels in the direction perpendicular to the surface of the coupled panels and/or into the direction perpendicular to the respective edges in the plane of the panels;
wherein the substrate comprises a thermoplastic polymer;
wherein the top layer is laminated onto the substrate by thermal lamination wherein bonds are formed between the thermoplastic polymer of the substrate and the same thermoplastic polymer in the top layer.

71. The decorative panel as in claim 70, wherein the top layer comprises a backing layer and wherein the same thermoplastic polymer in the top layer is provided in the backing layer of the top layer.

72. The decorative panel as in claim 70, wherein the thermoplastic polymer is selected from polyvinyl chloride, polyethylene, polypropylene, polyester, or polyamide.

73. The decorative panels as in claim 72, wherein the thermoplastic polymer is a polyester, and
wherein the thermoplastic adhesive is a co-polyester.
